(19) United States
(12) Patent Application Publication
(10) Pub. No.: US 2015/0205878 A1
(43) Pub. Date: Jul. 23, 2015

(54) Apparatus and Method for Display Activated Elective Message Tagging

(71) Applicant: Michael Robert Fox, Schaffhausen (CH)

(72) Inventor: Michael Robert Fox, Schaffhausen (CH)

(21) Appl. No.: 14/590,019

(22) Filed: Jan. 6, 2015

Related U.S. Application Data
(60) Provisional application No. 61/929,545, filed on Jan. 21, 2014.

(51) Int. Cl. G06F 17/30

(52) U.S. Cl. CPC G06F 17/30876; G06F 17/30321

(57) ABSTRACT

A computer-implemented method and apparatus for provisioning elective message tags within a smart display in the context of a ubiquitous computing operation.

### FIELD OF THE INVENTION

The present invention pertains to an improvement in the technical solution for provisioning elective message tags within a smart display in the context of a ubiquitous computing operation, and in particular, the present invention pertains to an apparatus and method for elective message tagging for a smart display in a ubiquitous computing operation which provides enhanced products and/or services for engineering, commerce, communications, entertainment, and other industries and individuals who or which utilize same.

### BACKGROUND OF THE INVENTION

Engineers, communications professionals, and marketers seeking to manage, inform, offer, and direct application or systems users, benefit from the use of message tags. Message tags contribute to the enablement of the conveyance of the message as well as information relevant to the content, or to the receiver of the message. Efficiently and effectively providing message tagging solutions is one fundamental challenges faced when architecting and engineering systems to provided benefits to message recipients. In our current age where privacy and security are constantly under threat by a substantial number of commercial and disreputable interests, having a secure alternative for the delivery of desired information is a benefit to society. By example, message tags can contain routing information, protocols, permissions, hyperlinks, advertisements, educational information, or other valuable data to the message recipient to assist with non-commercial and commercial purposes. With ever increasingly complex engineering, communications, and marketing endeavors undertaken, there is a continual increase the importance of and challenge associated with secure, efficient and effective tagging, particularly in public environments where smart displays might be present.

The ability to securely, effectively, and efficiently provision an elective message tag within a smart display in a ubiquitous computing operation [definition incorporated by reference: “Smart things: ubiquitous computing operation design”; Mike Kuniaysky; ISBN 9780123748997] can lead to the development of products and services in the United States and throughout the rest of the world that would benefit industry and individuals. Throughout past decades, innovations in tagging technologies have enabled the founding and growth of industries and improved lives of individuals due to the ability to improve the management, regulation, guidance, information, and offers associated with messages, while mitigating the erred, malicious, misdirected, and/or undesired messages.

Typically, engineers, communications professionals, and marketers have to rely on a limited scope of supply side paradigms for application related message tagging is needed. An example of this is where, marketers profile the personal data of individuals to submit an unrequested advertisement to an individual in a computing application in conjunction with the publishing of content of that application. Today, these practices often results in disequilibrium of control, security, and privacy between providers of messages, the enabling technology providers of such services, and the recipients of message tags.

The ability to apply a secure, versatile, controllable, customizable, and a readily available tagging system controlled by the message recipient would make the benefits of tagging more widely available to developers and users of engineered systems, devices, products, and services. The result being that many more people would benefit from improved systems, products, and services utilizing message tags.

### SUMMARY OF THE INVENTION

The present invention pertains to an improvement in the technical solution for provisioning elective message tags within a smart display in the context of a ubiquitous computing operation, and in particular, the present invention pertains to an apparatus and method for elective message tagging within a smart display in a ubiquitous computing operation, which provides enhanced products and/or services for engineering, commerce, communications, entertainment, and other industries and individuals who or which utilize same.

The present invention utilizes a computer implemented system with the following elements; an input unit, a storage unit, a central processing unit, wherein the central processing unit further includes an arithmetic logic unit and a control unit, and an output unit, wherein the output unit further includes communications unit, and wherein the functionality of such elements is understood to be accepting data or instructions as input, storing data and instruction, processing data as per the instructions, controlling all operations pertaining to the computer system, and giving results in the form of output.

The present invention utilizes three computing devices, one of which is a smart display. It is through interaction with the smart display that the personalization, security, and control aspects of the invention are effectuated. The second computing device, which may be for illustration purposes a smart phone, is detected in the presence of the smart display via wireless communication means. The smart phone, in this illustration, has a consumer identifier which is associated with the registered user of said smart phone. The consumer identifier, along with an app token associated with the smart display are transmitted for identification purposes to a third computing device, which for illustration purposes is a network-based computing service. Said consumer identifier and app token are validated by said network-based computing service as being, or not being, a registered consumer and app respectively. If both are validated a true response is sent to the smart display, and if configured as such, may be alternative sent to the smart phone or to both the smart display and smart phone. Upon receipt of the true response from the network-based computing service the smart display transmits a request to the network-based computing service for an elective message tag. The elective message tag, for purposes of illustration may be a consumer elected product or service category, a consumer elected brand, or other consumer elected information which they have opted-into receiving as elective message tags. The network-based computing service queries a database of said elective message tags to identify the appropriate tags. The network-based computing service transmits the requested elective message tag(s) to the smart display. The smart display will then present to the identified consumer an elective message tag that is associated with their consumer identifier. The result is that the consumer receives, at a smart display, an elected message tag which they have elected to receive, ensuring their privacy and security.

The present invention can be constructed as an apparatus or be a method that can be utilized to provide a comprehensive message tagging platform and/or service by which individuals, subscribers, registrants, and/or agents thereof can elect to, and register for receiving messages with information, data, communications, and offers, wherein the elected message tag is attached to, embedded in, and/or otherwise associated with a digital message or communication, or displayed within a smart display in a ubiquitous computing operation.

The present invention can be constructed as an apparatus or be a method that can be utilized in conjunction with computing platforms and systems.

The present invention can be constructed as an apparatus or be a method that can be utilized to facilitate services that occur in real-time.

The present invention can be constructed as an apparatus or be a method that can be utilized in conjunction with commercial transactions.

The present invention can be constructed as an apparatus or be a method that can be utilized with wireless communications, cloud-based computing, on-premise computing, smart display, and personal communications services and devices.

The present invention can be constructed as an apparatus or be a method that can be utilized in a network environment.

The present invention can be constructed as an apparatus or be a method that can be utilized in machine to machine communications.

The present invention can be constructed as an apparatus or be a method that can be utilized in conjunction with a monitoring system.

The present invention can be constructed as an apparatus or be a method that can be utilized in conjunction with an inventory management system.

The present invention can be constructed as an apparatus or be a method that can be utilized in conjunction with a service management system.

The present invention can be constructed as an apparatus or be a method that can be utilized in conjunction with movement sensing systems.

The present invention can be constructed as an apparatus or be a method that can be utilized in conjunction with geo-location systems.

The present invention can be constructed as an apparatus or be a method that can be utilized with a display trigger within a computing app.

The present invention can be constructed as an apparatus or be a method that can be customized in the display of a computing app.

The present invention can be constructed as an apparatus or be a method that can be utilized to enable users to elect a message tag.

The present invention can be constructed as an apparatus or be a method that can be configured to permit reactive, proactive, or dynamic changes to its elective message tagging parameters.

The present invention can be constructed as an apparatus or be a method that can be utilized in conjunction with contextual data.

The present invention can be constructed as an apparatus or be a method that can be utilized in conjunction with financial, news or other data providing systems.

The present invention can be constructed as an apparatus or be a method that can be utilized in conjunction with data analytics systems.

The present invention can be constructed as an apparatus or be a method that can be utilized in conjunction with security information systems.

The present invention can be constructed as an apparatus and method to deliver multiple units of elective message tags.

The present invention can be constructed as an apparatus and method to deliver hyperlinks as components of elective message tags.

The present invention can be constructed as an apparatus or be a method that can be utilized in conjunction with digital media distribution systems.

The present invention can be constructed as an apparatus or be a method that can be utilized in conjunction with a network based subscription management system.

The present invention can be constructed as an apparatus or be a method that can be utilized in conjunction with transmitting, receiving, and/or scanning devices.

The present invention can be constructed as an apparatus or be a method that can be utilized in conjunction with a fulfillment system.

The present invention can be constructed as an apparatus or be a method that can be utilized in conjunction with a plurality of end-point devices.

The present invention can be constructed as an apparatus or be a method that can be utilized over any suitable communication network and/or system.

The present invention can be constructed as an apparatus or be a method that can be utilized over any other suitable combination of communication networks.

The present invention can be constructed as an apparatus or be a method that can be utilized in conjunction with commercial vouchers.

The present invention can be constructed as an apparatus or be a method that can be utilized in conjunction with tickets.

The present invention can be constructed as an apparatus or be a method that can be utilized in conjunction with coupons.

The present invention can be constructed as an apparatus or be a method that can be utilized in conjunction with any point-of-sale transaction device.

The present invention can be constructed as an apparatus or be a method that can be utilized in conjunction with any point-of-sale transaction device.

The present invention can be constructed as an apparatus or be a method that can be utilized in conjunction with public digital smart display devices in a ubiquitous computing operation.

The present invention can be constructed as an apparatus or be a method that can be utilized in conjunction with wearable smart display devices in a ubiquitous computing operation.

The present invention can be constructed as an apparatus or be a method that can be utilized in conjunction with implantable smart display devices in a ubiquitous computing operation.

The present invention can be constructed as an apparatus or be a method that can be utilized in conjunction with structural smart display devices in a ubiquitous computing operation as used in the construction or ornamentation of a physical premise or vehicle.

The present invention can be constructed as an apparatus or be a method that can be utilized in conjunction with an ad network system.

The present invention can be constructed as an apparatus or be a method that can be utilized in conjunction with a mobile message delivery system.

The present invention can be constructed as an apparatus or be a method that can be utilized in conjunction with an app directory system.

The present invention can be constructed as an apparatus or be a method that can be utilized in conjunction with a dynamic folder system.

The present invention can be constructed as an apparatus or be a method that can be utilized in conjunction with third-party applications.

The present invention can be constructed as an apparatus or be a method that can be utilized in conjunction with intelligent agents.

The present invention can be constructed as an apparatus or be a method that can be utilized in conjunction with pre-restriction functionality.

The present invention can be constructed as an apparatus or be a method that can be utilized in conjunction with limitation functionality.

The present invention can be constructed as an apparatus or be a method that can be utilized in conjunction with a financial transaction processing system.

The present invention can be constructed as an apparatus or be a method that can be utilized in conjunction with a banking system.

The present invention can be constructed as an apparatus or be a method that can be utilized in conjunction with a value storage system.

The present invention can be constructed as an apparatus or be a method that is programmable.

The communication link between the first and second computing devices of the present invention can be triggered by proximity of the computing devices, or by physical contact of the devices.

Other objects and advantages of the present invention will be apparent to those skilled in the art upon a review of the Description of the Preferred Embodiment taken in conjunction with the Drawings which follow.

### DESCRIPTION OF THE PREFERRED EMBODIMENTS

The present invention pertains to an improvement in the technical solution for provisioning elective message tags within a smart display in the context of a ubiquitous computing operation, which provides for the secure and reliable delivery of elective message tags.

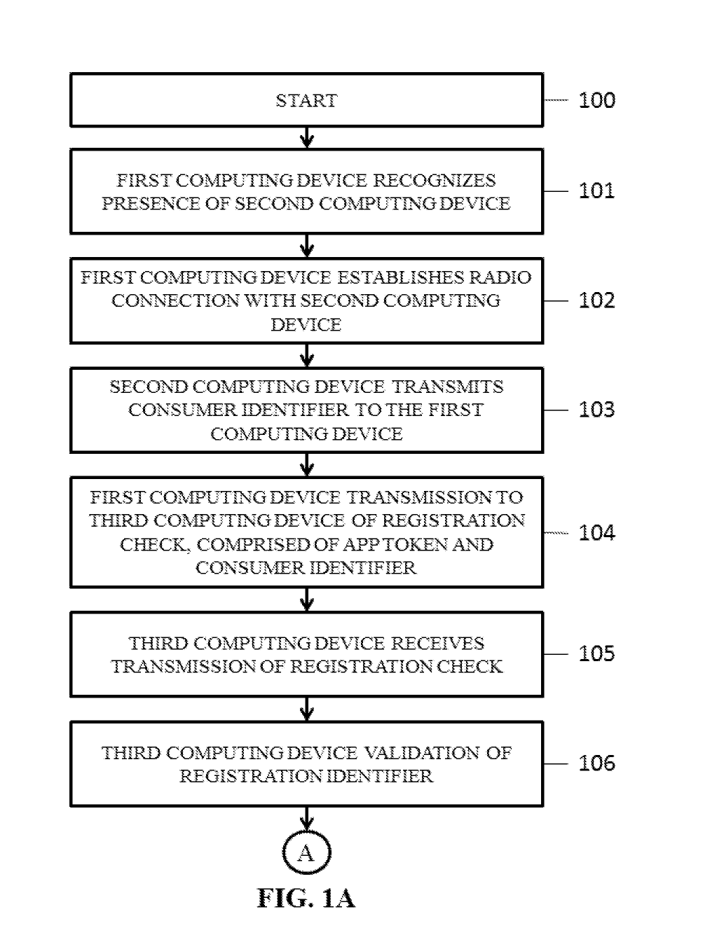

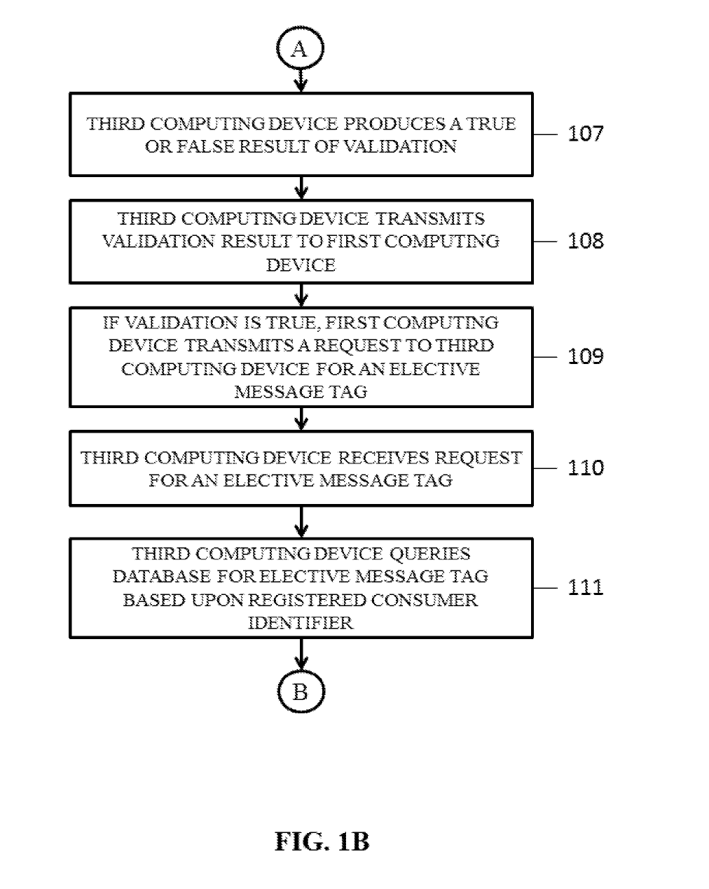

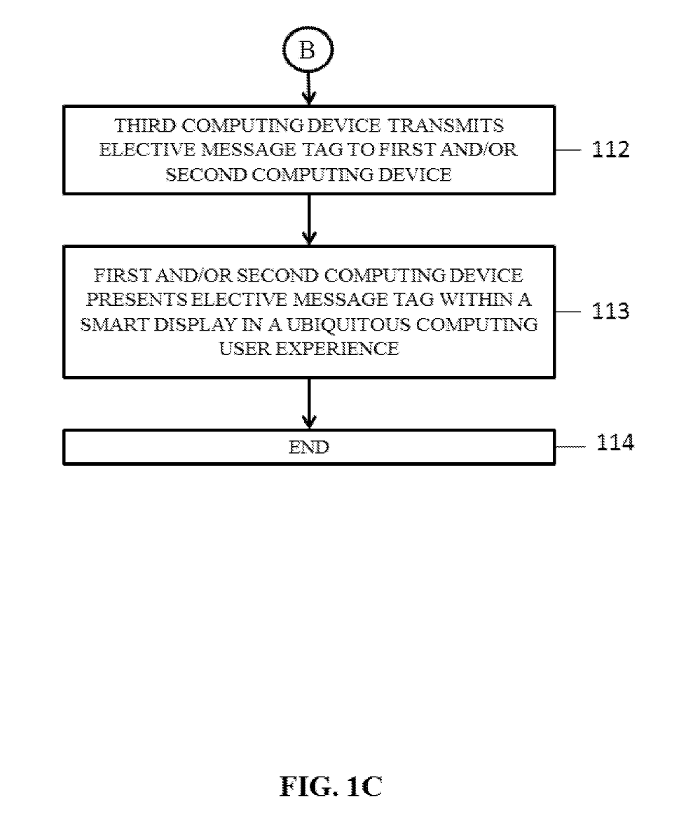

FIGS. 1A, 1B, and 1C illustrate a flow diagram of a preferred embodiment of the present invention wherein the present invention is utilized to provision elective message tags within a smart display in the context of a ubiquitous computing operation.

The operation of the embodiment of FIGS. 1A, 1B, and 1C commences at Step 100. At Step 101, a first computing device recognizes the presence of a second computing device, where said first computing device is a smart display. Then at Step 102, the first computing device establishes a wireless communication with the second computing device. At Step 103 the second computing device transmits a consumer identifier to the first computing device. At Step 104, the first computing device transmits a registration check to a third computing device, where said registration check is an app token and a consumer identifier. At Step 105 the third computing device receives said transmission of an app token and a consumer identifier. At Step 106 the third computing device performs a validation of the app token and the consumer identifier. At Step 107 the third computing device produces a true or false result. At Step 108 the third computing device transmits the result of the validation to the first computing device. In the case of a true validation result, at Step 109 the first computing device transmits a request to the third computing device for an elective message tag. At Step 110 the third computing device receives the request from the first computing device for an elective message tag. At Step 111 the third computing device queries a database of consumer message tags, where consumer elective message tags are identified based upon registered consumer identifier. At Step 112 the third computing device transmits the requested elective message tags to first and/or second computing device. At Step 113 the first computing device and/or the second computing device presents the elective message tags within a smart display in a ubiquitous computing operation. Thereafter, the operation of the embodiment of FIGS. 1A, 1B and 1C will cease at Step 114.

In a preferred embodiment, the method of the present invention facilitates receiving an elective message tag as a presentation within a smart display in a ubiquitous computing operation, comprising the steps of: a first device recognition of presence device of a computing device, where said first computing device is a smart display; causing the first computing device to establish wireless communication with the second computing device, where proximity of the second computing device or physical contact of devices triggers the communication link; causing the second computing device to transmit a consumer identifier to the first computing device; transmitting a registration check from a first computing device to a third computing device, where said registration check is an app token and a consumer identifier; causing third computing device to receive said transmission of an app token and a consumer identifier; causing third computing device to perform a validation of the app token and the consumer identifier, whereby the. validation produces a true or false result; causing the third computing device to transmit the result of the validation to the first computing device; causing a the first computing device to transmit, in the case of a true validation result, a request to the third computing device for an elective message tag; causing third computing device to query a database of consumer message tag elections, where consumer elective message tag is identified based upon registered consumer identifier; causing third computing device to transmit elective message tag to first computing device; causing first computing device to present elective message tag within a smart display in a ubiquitous computing operation.

In a preferred embodiment of the apparatus and method of the present invention the recognition of a second computing device by a first computing device is conducted by wireless network scanning, wireless networking pinging, software code for presence identification, artificially intelligent programs, algorithms, or any other suitable wireless networking device identification means.

In a preferred embodiment of the apparatus and method of the present invention the recognition of a second computing device by a first computing device is conducted by near field communications (NFC) [definition incorporated by reference “Near field communication: from theory to practice”; Vedat Coscun, Kerem Ok, and Busra Ozdenizci; ISBN 9781119971], where presence of a second device and communications between first and second devices is enabled by NFC.

In a preferred embodiment of the apparatus and method of the present invention, the communication link between the first and second computing devices is triggered by proximity of the computing devices.

In a preferred embodiment of the apparatus and method of the present invention, the communication link between the first and second computing devices is triggered by physical contact of the devices.

In a preferred embodiment of the method of the present invention the elective message tag is located, generated, or stored at the third computing device.

In a preferred embodiment of the method of the present invention the first and second and third computing devices are able to calculate, or record, or store, or any combination of calculate, record, or store elective message tags, elective message tag data, or smart display data, or any combination of elective message tags, elective message tag data, or smart display data.

In a preferred embodiment of the method of the present invention the consumer identifier is one of is a mobile telephone number, an email, a third-party identification element, or a federated identification [definition incorporated by reference “Liberty Alliance Project White Paper: Liberty ID-WSF People Service—federated social identity” Madsen, Paul, ed. (5 Dec. 2005)].

In a preferred embodiment of the method of the present invention the consumer identifier is a mobile telephone number, or an email, or a third-party identification element, or a federated identification, or any combination of a mobile telephone number, an email, a third-party identification element, or a federated identification.

In a preferred embodiment of the method of the present invention the consumer identifier is preprogrammed to transmit from the second computing device.

In a preferred embodiment of the method of the present invention the first computing device is able to store instructions for elective message tag presentation.

In a preferred embodiment of the method of the present invention the second computing device is able to store instructions for elective message tags.

In a preferred embodiment of the method of the present invention the third computing device is able to store instructions for elective message tags.

In a preferred embodiment of the method of the present invention the second computing device is a point of sale device able to process transactions for goods and services.

In a preferred embodiment of the method of the present invention the first computing device, or second computing device, or third computing device, or any combination of the first computing device, second computing device, or third computing device are able to provide access to hyperlinks.

In a preferred embodiment of the method of the present invention the first and second and third computing devices are each able to calculate and record elective message tag data.

In a preferred embodiment of the method of the present invention the first computing device is a cloud computing enabled computing device.

In a preferred embodiment of the method of the present invention the second computing device is a cloud computing enabled computing device.

In a preferred embodiment of the method of the present invention the third computing device is a cloud computing enabled computing device.

In a preferred embodiment of the method of the present invention hyperlinks are components of elective message tags.

In a preferred embodiment of the method of the present invention the digital environment of the first computing device exists within a virtual premise.

In a preferred embodiment of the method of the present invention the digital environment of the second computing device exists within a virtual premise.

In a preferred embodiment of the method of the present invention the communication between and any combination of the first computing device, the second computing device, or the third computing device are encrypted.

In a preferred embodiment of the method of the present invention the first computing device, the second computing device, or the third computing device, or any combination of the first computing device, the second computing device, or the third computing device use decryption software.

In a preferred embodiment of the method of the present invention the first and second and third computing devices store data of elective message tags and smart displays.

In a preferred embodiment of the method of the present invention the first transmission of a registration check originates or terminates, or originates and terminates at public computing device.

In a preferred embodiment of the method of the present invention the third computing device transmits directly to the first computing device. Alternatively, in a preferred embodiment of the method of the present invention the third computing device transmits to the second computing device. Alternatively, in a preferred embodiment of the method of the present invention the third computing device transmits to the first and/or second computing device and either or both of the receiving devices further transits to the other, wherein one or both of the first and/or second computing devices is able to display the elective message tag.

In a preferred embodiment, the apparatus of the present invention facilitates receiving an elective message tag as a presentation within a smart display in a ubiquitous computing operation, comprising: three computing devices, wherein a first computing device recognizes the presence of a second computing device, where said first computing device is a smart display; wherein the first computing device establishes wireless communication with the second computing device, where proximity of the second computing device or physical contact of devices triggers the communication link; wherein the second computing device transmits a consumer identifier to the first computing device; where first computing device transmits a registration check to a third computing device, where said registration check is an app token and a consumer identifier; wherein said third computing device receives said transmission of an app token and a consumer identifier; wherein third computing device performs a validation of the app token and the consumer identifier, whereby the validation produces a true or false result; wherein the third computing device transmits the result of the validation to the first computing device; wherein the first computing device transmits, in the case of a true validation result, a request to the third computing device for an elective message tag; wherein the third computing device queries a database of consumer message tag elections, where consumer elective message tag is identified based upon registered consumer identifier; wherein third computing device transmits elective message tag to first computing device; wherein first computing device presents elective message tag within a smart display in a ubiquitous computing operation.

In a preferred embodiment of the apparatus of the present invention the consumer identifier is a mobile telephone number, or an email, or a third-party identification element, or a federated identification, or any combination of a mobile telephone number, an email, a third-party identification element, or a federated identification.

In a preferred embodiment of the apparatus of the present invention the first computing device, or second computing device, or third computing device, or any combination of the first computing device, second computing device, or third computing device are able to provide access to hyperlinks.

In a preferred embodiment of the apparatus of the present invention the first and second and third computing devices are able to calculate, or record, or store, or any combination of calculate, record, or store elective message tags, elective message tag data, or smart display data, or any combination of elective message tags, elective message tag data, or smart display data.

In a preferred embodiment of the apparatus of the present invention the communication between and any combination of the first computing device, the second computing device, or the third computing device are encrypted.

In a preferred embodiment of the apparatus of the present invention the first computing device, the second computing device, or the third computing device, or any combination of the first computing device, the second computing device, or the third computing device use decryption software.

In a preferred embodiment of the apparatus of the present invention the first transmission of a registration check originates at public computing device.

In a preferred embodiment of the apparatus of the present invention the transmission of the elective message tag terminates at a public computing device.

In a preferred embodiment of the apparatus of the present invention the transmission of the elective message tag originates and terminates at a public computing device.

In a preferred embodiment of the apparatus of the present invention the second computing device is a point of sale device able to process transactions for goods and services.

In a preferred embodiment of the apparatus of the present invention the elective message tag is located or generated or stored, or any combination of located, generated, or stored at the first computing device.

In a preferred embodiment of the apparatus of the present invention the third computing device transmits directly to the first computing device. Alternatively, in a preferred embodiment of the apparatus of the present invention the third computing device transmits to the second computing device. Alternatively, in a preferred embodiment of the apparatus of the present invention the third computing device transmits to the first and/or second computing device and either or both of the receiving devices further transits to the other, wherein one or both of the first and/or second computing devices is able to display the elective message tag.

In a preferred embodiment of the apparatus and method of the present invention, a computer program product comprises a computer usable medium having control logic stored therein for causing computers to receive an elective message tag as a presentation within a smart display in a ubiquitous computing operation in a digital environment comprising: a first computer readable program code means for establishing wireless communication with a second computing device, where proximity of the second computing device or physical contact of devices triggers the communication link; second computer readable program code means for transmitting a consumer identifier to the first computing device; first computer readable program code means for transmitting a registration check to a third computing device, where said registration check is an app token and a consumer identifier; third computer readable program code means for receiving said transmission of an app token and a consumer identifier; third computer readable program code means for validating the app token and the consumer identifier, whereby the validation produces a true or false result; third computer readable program code means for transmitting the result of the validation to the first computing device; first computer readable program code means for transmitting, in the case of a true validation result, a request to the third computing device for an elective message tag; third computer readable program code means for querying a database of consumer message tag elections, where consumer elective message tag is identified based upon registered consumer identifier; third computer readable program code means for transmitting elective message tag to first computing device; first computer readable program code means for presenting elective message tag within a smart display in a ubiquitous computing operation.

In a preferred embodiment of the apparatus and method of the present invention the first, second, and third computers each individually has readable program code means for causing the first, second, and third computers to respectively execute a computerized command for recording of the presentation of the elective message tag.

What is claimed is:

1. A method for facilitating the provisioning of an elective message tag as a presentation within a smart display in a ubiquitous computing operation, comprising the steps of: a first computing device recognition of the presence of a second computing device, where said first computing device is a smart display; causing the first computing device to establish wireless communication with the second computing device; causing the second computing device to transmit a consumer identifier to the first computing device; transmitting a registration check from a first computing device to a third computing device, where said registration check is an app token and a consumer identifier; causing third computing device to receive said transmission of an app token and a consumer identifier; causing third computing device to perform a validation of the app token and the consumer identifier, whereby the validation produces a true or false result; causing the third computing device to transmit the result of the validation to the first computing device; causing a the first computing device to transmit, in the case of a true validation result, a request to the third computing device for an elective message tag; causing third computing device to query a database of consumer message tag elections, where consumer elective message tag is identified based upon registered consumer identifier; causing third computing device to transmit elective message tag to first computing device; causing first computing device to present elective message tag within a smart display in a ubiquitous computing operation.

2. The method of claim 1, wherein the elective message tag is located or generated or stored, or any combination of located, generated, or stored at the first computing device.

3. The method of claim 1, wherein the consumer identifier is a mobile telephone number, or an email, or a third-party identification element, or a federated identification, or any combination of a mobile telephone number, an email, a third-party identification element, or a federated identification.

4. The method of claim 1, where the consumer identifier is preprogrammed to transmit from the second computing device.

5. The method of claim 1, wherein the first computing device is able to store instructions for elective message tag presentation.

6. The method of claim 1, wherein the second computing device operates as a point of sale device.

7. The method of claim 1, wherein the first computing device, or second computing device, or third computing device, or any combination of the first computing device, second computing device, or third computing device are able to provide access to hyperlinks.

8. The method of claim 1, wherein the first and second and third computing devices are able to calculate, or record, or store, or any combination of calculate, record, or store elective message tags, elective message tag data, or smart display data, or any combination of elective message tags, elective message tag data, or smart display data.

9. The method of claim 1, wherein the first computing device, or the second computing device, or the third computing device, or any combination of the first computing device, the second computing device, and the third computing device are a cloud based computing devices.

10. The method of claim 1, wherein hyperlinks are components of elective message tags.

11. The method of claim 1, wherein the smart display exists within a virtual premise.

12. The method of claim 1, wherein the communication between and any combination of the first computing device, the second computing device, or the third computing device are encrypted.

13. The method of claim 1, wherein the first computing device, the second computing device, or the third computing device, or any combination of the first computing device, the second computing device, or the third computing device use decryption software.

14. The method of claim 1, wherein the elective message tags are received at a smart display or a second computing device, or a smart display and a second computing device.

15. An apparatus for facilitating the provisioning of an elective message tag as a presentation within a smart display in a ubiquitous computing operation, comprising: three computing devices, wherein a first computing device recognizes the presence of a second computing device, where said first computing device is a smart display; wherein the first computing device establishes wireless communication with the second computing device; wherein the second computing device transmits a consumer identifier to the first computing device; where first computing device transmits a registration check to a third computing device, where said registration check is an app token and a consumer identifier; wherein said third computing device receives said transmission of an app token and a consumer identifier; wherein third computing device performs a validation of the app token and the consumer identifier, whereby the validation produces a true or false result; wherein the third computing device transmits the result of the validation to the first computing device; wherein the first computing device transmits, in the case of a true validation result, a request to the third computing device for an elective message tag; wherein the third computing device queries a database of consumer message tag elections, where consumer elective message tag is identified based upon registered consumer identifier; wherein third computing device transmits elective message tag to first computing device; wherein first computing device presents elective message tag within a smart display in a ubiquitous computing operation.

16. The apparatus of claim 15, wherein the first transmission of a registration check originates or terminates, or originates and terminates at public computing device.

17. The apparatus of claim 15, wherein the first computing device, the second computing device, or the third computing devices, or any combination of the first computing device, the second computing device, or the third computing device is able to calculate, record, or store, or any combination of calculate, record, or store elective message tags, elective message tag data, or smart display data, or any combination of elective message tags, elective message tag data, or smart display data.

18. The apparatus of claim 15, wherein the smart display or the second computing device, or the smart display and the second computing device operates as a point of sale device.

19. A non-transitory computer program product comprises a computing device usable medium having control logic stored therein for causing computers to provision an elective message tag as a presentation within a smart display in a ubiquitous computing operation in a digital environment comprising: a first computing device readable program code means for establishing wireless communication with a second computing device; second computer readable program code means for transmitting a consumer identifier to the first computing device; first computer readable program code means for transmitting a registration check to a third computing device, where said registration check is an app token and a consumer identifier; third computer readable program code means for receiving said transmission of an app token and a consumer identifier; third computer readable program code means for validating the app token and the consumer identifier, whereby the validation produces a true or false result; third computer readable program code means for transmitting the result of the validation to the first computing device; first computer readable program code means for transmitting, in the case of a true validation result, a request to the third computing device for an elective message tag; third computer readable program code means for querying a database of consumer message tag elections, where consumer elective message tag is identified based upon registered consumer identifier; third computer readable program code means for transmitting elective message tag to first computing device; first computer readable program code means for presenting elective message tag within a smart display in a ubiquitous computing operation.

20. The apparatus of claim 19 where the first computing device, or the second computing device, or the third computing device, or any combination of the first computing device, or the second computing device, or the third computing device has readable program code means for causing the first computing device, or the second computing device, or the third computing device, or any combination of the first computing device, or the second computing device, or the third computing device to execute a computerized command for recording of the presentation of an elective message tag.
